(19) United States
(12) Patent Application Publication
(10) Pub. No.: US 2023/0219364 A1
(43) Pub. Date: Jul. 13, 2023

(54) SEALABLE PAINT CAN LINER

(71) Applicant: Fred GROSSCUP, Levittown, PA (US)

(72) Inventor: Fred GROSSCUP, Levittown, PA (US)

(21) Appl. No.: 18/096,630

(22) Filed: Jan. 13, 2023

Related U.S. Application Data
(60) Provisional application No. 63/299,134, filed on Jan. 13, 2022.

(51) Int. Cl. B44D 3/12

(52) U.S. Cl. CPC B44D 3/12

(57) ABSTRACT

A reusable paint can liner for preserving paint poured into a container for use. The liner includes a base, a first side, and a second side, each of the first and second sides each having a bottom portion, first and second side portions, and a top portion. The bottom portion of the first side and the bottom portion of the second side are permanently affixed to the base, the first side portion of the first side is permanently affixed to the first side portion of the second side, and the second side portion of the first side is permanently affixed to the second side portion of the second side. The top portion of the first side is selectively sealable to the top portion of the second side.

### CROSS-REFERENCE TO RELATED APPLICATIONS

The present application claims the benefit of U.S. Provisional Patent Application No. 63/299,134, filed on Jan. 13, 2022 and titled “Sealable paint can liner,” the entire contents of which are incorporated herein by reference in their entirety.

### BACKGROUND OF THE INVENTION

Traditionally, a painter will pour paint into one of many types of receptacles while painting. However, at the end of a work day, the paint must be poured back into a sealable container to avoid drying out, which necessitates additional effort and increases the chances of spilling paint. Therefore, a need exists for a sealable liner that can be fitted to the inside of a paint receptacle so that a painter can simply seal the paint at the end of the day without transferring it to another vessel.

### BRIEF SUMMARY OF THE INVENTION

Briefly stated, one exemplary aspect of the present invention is directed to a reusable paint can liner for preserving paint poured into a container for use. The liner includes a base, a first side, and a second side, each of the first and second sides each having a bottom portion, first and second side portions, and a top portion. The bottom portion of the first side and the bottom portion of the second side are permanently affixed to the base, the first side portion of the first side is permanently affixed to the first side portion of the second side, and the second side portion of the first side is permanently affixed to the second side portion of the second side. The top portion of the first side is selectively sealable to the top portion of the second side.

Another exemplary aspect of the present invention is directed to a painting kit having a rigid container with a flat bottom, a vertical wall, and an open top, the flat bottom, vertical wall, and open top defining a cavity; and a liner configured to fit within the cavity, the liner having a base, a side having a bottom portion and a top portion, the bottom portion of the side being permanently affixed to or integrally formed with the base, and the top portion having a fastening mechanism configured to be alternated between an opened position and a sealed position.

Another exemplary aspect of the present invention is directed to a method for preserving paint having the steps of placing a liner having a base, a side portion, and a selectively sealable top portion within a rigid container having a flat bottom, a vertical wall, and an open top; ensuring the base is in facing engagement with the flat bottom, the side portion is in facing engagement with the vertical wall, and the sealable top portion extends beyond the open top; securing the top portion around the open top or vertical wall of the rigid container; pouring paint into the liner; and sealing the top portion.

### BRIEF DESCRIPTION OF THE SEVERAL VIEWS OF THE DRAWINGS

The foregoing summary, as well as the following detailed description of exemplary embodiments of the present invention, will be better understood when read in conjunction with the appended drawings. For the purposes of illustrating the present invention, there are shown in the drawings exemplary embodiments. It should be understood, however, that the invention is not limited to the precise arrangements and instrumentalities shown. In the drawings:

FIG. 1 illustrates a side elevational, exploded view of a painting kit including a reusable paint liner and a rigid container or handy paint pail in accordance with a first exemplary embodiment of the present invention, as well as a top plan view of the reusable paint liner in an open configuration;

FIG. 2 illustrates a top perspective view of a painting kit, including a rigid container and a paint liner in accordance with a second exemplary embodiment of the present invention;

FIG. 3 illustrates a top perspective view of a painting kit of FIG. 2, wherein the paint liner is being inserted into the rigid container;

FIG. 4 illustrates an alternative top perspective view of the painting kit of FIG. 2, wherein the paint liner is being inserted into the rigid container; and

FIG. 5 illustrates a flow chart of a method for preserving paint in accordance with a third exemplary embodiment of the present invention.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right”, “left”, “lower” and “upper” designate directions in the drawings to which reference is made. The words “inwardly” or “distally” and “outwardly” or “proximally” refer to directions toward and away from, respectively, the patient's body, or the geometric center of the preferred dental imaging system and related parts thereof. The words, “anterior”, “posterior”, “superior,” “inferior”, “lateral” and related words and/or phrases designate preferred positions, directions and/or orientations in the human body to which reference is made and are not meant to be limiting. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

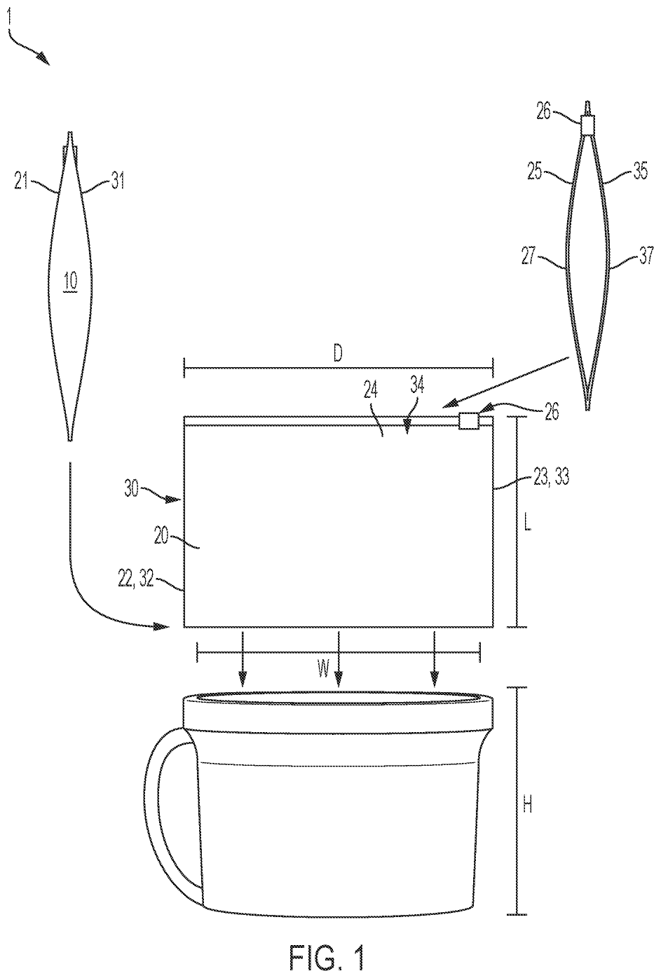

Referring to FIG. 1, one exemplary embodiment of the present invention is directed to a reusable paint can liner 1 for preserving paint poured into a container or handy paint pail for use. The liner 1 preferably includes a base 10, a first side 20, and a second side 30. The first side 20 and second side 30 preferably each include a bottom portion 21, 31, a first side portion 22, 32, a second side portion 23, 33, and a top portion 24, 34. In the first exemplary embodiment, the bottom portion 21 of the first side 20 and the bottom portion 31 of the second side 30 are permanently affixed to the base 10; the first side portion 22 of the first side 20 is permanently affixed to the first side portion 32 of the second side 30; and the second side portion 23 of the first side 20 is permanently affixed to the second side portion 33 of the second side 30. The top portion 24 of the first side 20 is preferably selectively sealable to the top portion 34 of the second side 30. Preferably, the selective sealing is configured to be alternated between an opened position and a sealed position. More preferably, the selective sealing is accomplished through use of a fastening mechanism 26, preferably a sliding fastening mechanism 26, attached to top edges 25, 35 of top portions 24, 34 of the first side 20 and second side 30, the fastening mechanism 26 configured to alternate the top portions 24, 34 between the opened position and the sealed position.

In the first exemplary embodiment, the first and second side portions 22, 32, 23, 33 of the first and second sides 20, 30 preferably have a length L of approximately eight (8) inches, the bottom portions 21, 31 of the first and second sides 20, 30 preferably have a width W of approximately nine-and-one-half (9.5) inches, the top portions 24, 34 of the first and second sides 20, 30 preferably have a depth D of approximately eleven-and-one-half (11.5) inches, and the first and second sides 20, 30 are preferably configured to be spaced apart by at least three inches at center points 27, 37 of the top portions of the first and second sides when the top portions are in the opened position. The liner 1 is not limited to having these specific dimensions and is preferably sized and configured to fit into the associated hardy paint pail or rigid container that is being used to hold the liner 1 and paint during use. The first side 20 and second side 30 are preferably constructed of a substantially non-porous material, more preferably of a polymeric material, but are not so limited.

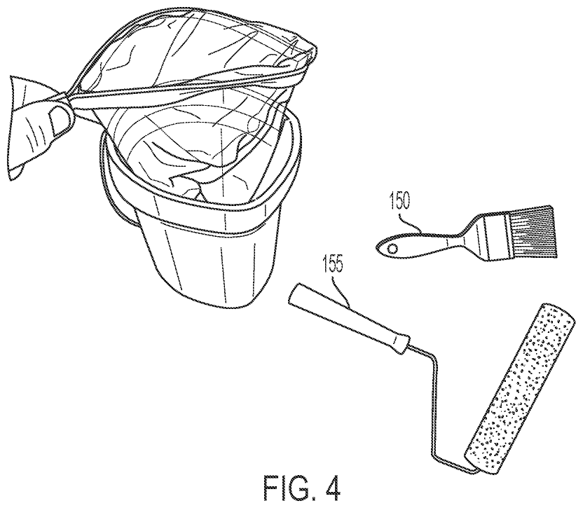

Referring now to FIGS. 1-4, a second exemplary embodiment of the invention is shown. The second exemplary embodiment includes a painting kit 101 having a rigid container 140 with a flat bottom 141, a vertical wall 142, and an open top 143. The flat bottom 141, vertical wall 142, and open top 143 preferably define a cavity 144. The cavity preferably has a volume of approximately one quart. The rigid container 140 preferably also has a lip 145 situated proximate the open top 143. The rigid container 140 also preferably includes a handle 146. In the second exemplary embodiment, the rigid container 140 is preferably constructed of a polymeric material, but is not so limited. Preferably, the flat bottom 141 and the vertical wall 142 define a substantially cylindrical shape, but the invention is not so limited.

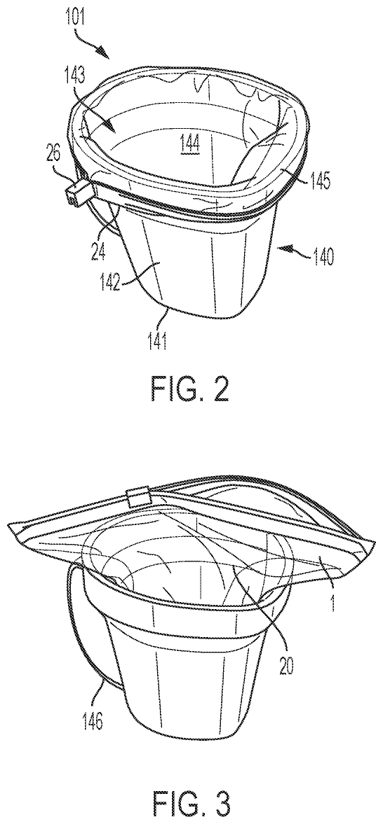

The kit 101 of the second exemplary embodiment also preferably includes the liner 1 configured to fit within the cavity 144,. The bottom portion 21 of the first side 20 is preferably permanently affixed to or integrally formed with the base 10 and the top portion 24 having the fastening mechanism 26 configured to be alternated between an open position and a sealed position. The fastening mechanism 26 is preferably a sliding fastener, but is not so limited and may be any device capable of fastening, such as hook-and-loop, snaps, buttons, clips, and the like. The liner 1 is preferably configured to be secured around the lip 145 when the top portion 24 is in the opened position, as shown in FIG. 2. The liner 1 preferably has a volume of approximately one quart. Preferably, the base 10 and the sides 20, 30 of the liner 1 define a substantially cylindrical shape, but the invention is not so limited.

In order to provide for the most efficient retrieval of paint, the liner 10 is preferably configured to be in facing engagement with the inner surfaces of the rigid container 140. To achieve this, the base 10 of the liner 1 preferably has approximately the same dimensions as the flat bottom 141 of the rigid container 140; the vertical wall 142 of the rigid container 140 has a height H and the length L of the sides 20, 30 is preferably greater than the height H. In this way, the base 10 can be placed into facing engagement with the flat bottom 141 of the rigid container and the sides 20, 30 can be placed into facing engagement with the vertical wall 142 of the rigid container 140, with the top portion 24 and fastening mechanism 26 of the liner 1 extending beyond the open top 143 of the rigid container 140 such that a user can easily access and close the fastening mechanism 26 to preserve any paint poured within.

The kit 101 of the second exemplary embodiment also preferably includes a paint brush 150 or a paint roller 155.

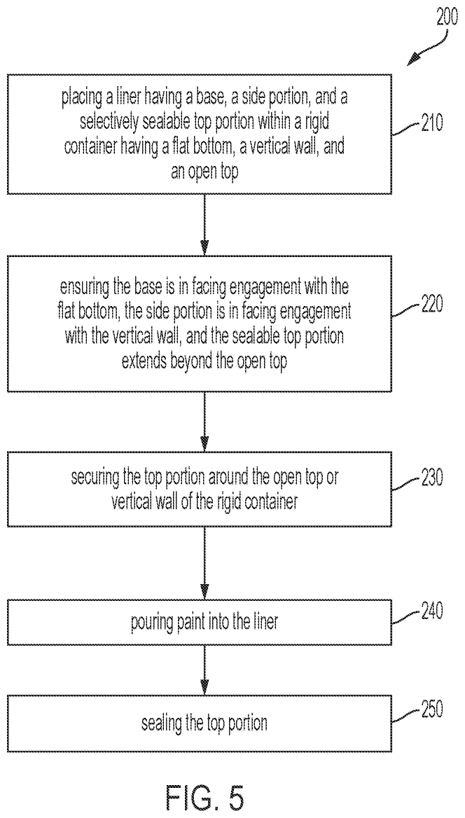

Referring to FIG. 5, a third exemplary embodiment of the present invention is shown depicting a method 200 for storing paint in accordance with aspects of the present invention. The method preferably comprises a first step 210 of placing a liner having a base, a side portion, and a selectively sealable top portion within a rigid container having a flat bottom, a vertical wall, and an open top. The method also preferably comprises a second step 220 of ensuring the base is in facing engagement with the flat bottom, the side portion is in facing engagement with the vertical wall, and the sealable top portion extends beyond the open top. The method further preferably comprises a third step 230 of securing the top portion around the open top or vertical wall of the rigid container. The method preferably comprises a fourth step 240 of pouring paint into the liner and a fifth step 250 of sealing the top portion.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

I/We claim:

1. A reusable paint can liner for preserving paint poured into a container for use, the reusable paint can liner comprising:
a base, a first side, and a second side, the first and second sides each having a bottom portion, first and second side portions, and a top portion;
the bottom portion of the first side and the bottom portion of the second side being permanently affixed to the base;
the first side portion of the first side being permanently affixed to the first side portion of the second side;
the second side portion of the first side being permanently affixed to the second side portion of the second side; and
the top portion of the first side being selectively sealable to the top portion of the second side, the selective sealing being configured to be alternated between an opened position and a sealed position.

2. The paint can liner of claim 1, further comprising:
a sliding fastening mechanism attached to top edges of the top portions of the first and second sides, the sliding fastening mechanism configured to alternate the top portions between the opened position and the sealed position.

3. The paint can liner of claim 1, wherein the first and second side portions of the first and second sides have a length of approximately eight (8) inches, the bottom portions of the first and second sides have a width of approximately nine-and-one-half (9.5) inches, the top portions of the first and second sides have a depth of approximately eleven-and-one-half (11.5) inches, the first and second sides configured to be spaced apart by at least three inches at center points of the top portions of the first and second sides when the top portions are in the opened position.

4. The paint can liner of claim 1, wherein the first and second sides are constructed of a substantially non-porous material.

5. The paint can liner of claim 4, wherein the substantially non-porous material is a polymeric material.

6. A painting kit comprising:
a rigid container having a flat bottom, a vertical wall, and an open top, the flat bottom, vertical wall, and open top defining a cavity; and
a liner configured to fit within the cavity, the liner having:
a base;
a side having a bottom portion and a top portion, the bottom portion of the side being permanently affixed to or integrally formed with the base; and
the top portion having a fastening mechanism configured to be alternated between an opened position and a sealed position.

7. The painting kit of claim 6, wherein the rigid container further comprises a lip situated proximate the open top.

8. The painting kit of claim 7, wherein the liner is configured to be secured around the lip when the top portion is in the opened position.

9. The painting kit of claim 6, wherein the rigid container further comprises a handle.

10. The painting kit of claim 6, wherein the rigid container is constructed of a polymeric material.

11. The painting kit of claim 6, wherein the fastening mechanism is a sliding fastener.

12. The painting kit of claim 6, further comprising:
a paint brush.

13. The painting kit of claim 6, wherein the cavity has a volume of approximately one quart.

14. The painting kit of claim 6, wherein the liner has a volume of approximately one quart.

15. The painting kit of claim 6, wherein the base has approximately the same dimensions as the flat bottom of the rigid container, the vertical wall of the rigid container has a height, and the side of the liner has a liner width, the liner width being greater than the height of the vertical wall, the base is configured to be in facing engagement with the flat bottom and the vertical wall when the liner is placed in the cavity.

16. The painting kit of claim 6, wherein the flat bottom and the vertical wall define a substantially cylindrical shape and the base and the side of the liner define a substantially cylindrical shape.

17. A method for preserving paint, the method comprising:
placing a liner having a base, a side portion, and a selectively sealable top portion within a rigid container having a flat bottom, a vertical wall, and an open top;
ensuring the base is in facing engagement with the flat bottom, the side portion is in facing engagement with the vertical wall, and the sealable top portion extends beyond the open top;
securing the top portion around the open top or vertical wall of the rigid container;
pouring paint into the liner; and
sealing the top portion.
